(19) United States
(12) Patent Application Publication
(10) Pub. No.: US 2018/0199147 A1
(43) Pub. Date: Jul. 12, 2018

(54) Portable Bluetooth Audio Hub

(71) Applicant: Ryan James Arriaga, Lincoln, CA (US)

(72) Inventor: Ryan James Arriaga, Lincoln, CA (US)

(73) Assignee: Ryan James Arriaga, Lincoln, CA (US)

(21) Appl. No.: 15/399,748

(22) Filed: Jan. 6, 2017

(51) Int. Cl. H04W 4/00; H04M 1/725; H04W 56/00; H04W 76/02

(52) U.S. Cl. CPC H04W 4/008; H04W 76/023; H04W 56/001; H04M 1/7253

(57) ABSTRACT

The present invention relates to a portable Bluetooth audio hub which can connect to multiple Bluetooth devices at once by way of a Mobile Application (App). Therefore, this invention particularly allows users to operate and channel audio to several Bluetooth speakers simultaneously from a single mobile app. The User may register on the App by entering the 9 digit unique security number present on the device. Once the user is registered, he may sync multiple devices to the App and create Groups. The user can stream the audio only to multiple connected devices at a single instance. User may also de-sync or ‘forget’ the devices to which he does not want to connect further.

### CROSS-REFERENCE TO RELATED APPLICATIONS

Provisional Patent Application No. 62/383,751

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present invention relates to a portable Bluetooth audio hub which can connect to multiple Bluetooth devices at once by way of a Mobile Application (App). Therefore, this invention particularly allows users to operate and channel audio to several Bluetooth speakers simultaneously from a single mobile app.

The science and technology has advanced in leaps and bounds and the quality of life has increased significantly. Currently, the devices with Bluetooth connectivity only allow a user with an option to listen to audio through Bluetooth integrated speakers only and which can be connected to a mobile application without allowing multiple connectivity to the speakers. The present invention is an improvement over this functionality. Some of the prior arts in this field are detailed in this application.

The Patent U.S. Pat. No. 9,078,058 B2 presents a two-way speaker which increases fidelity of the sound. Speakers can acknowledge receipt of audio data packets. This provides increased functionality because the audio hub can receive data not only from wired inputs, but also wireless transmission from computers, cell phones and other sources. The audio hub can use information from the speakers to customize/adjust the audio signal for each speaker independently and also achieve better synchronization among the speakers. But the prior art does not present a hub that is in turn synced to a mobile phone app and controlled or operated via mobile phone app. Another Patent U.S. Pat. No. 9,414,166 B2 contains a peripheral hub comprising a housing; a communication module for wirelessly communicating with a plurality of mobile devices; a processing unit to process wireless communications from the plurality of mobile devices; a loudspeaker system to stream audio received from the plurality of mobile devices; and an internal cavity area beneath the movable cover, the internal cavity area for storing at least one accessory input device for use with at least one of the plurality of mobile devices; wherein the loudspeaker system comprises (i) a subwoofer formed on an underside of the housing opposite the movable cover, and (ii) a plurality of speaker areas formed around the underside of the housing and surrounding the subwoofer. The prior art again does not disclose the features of multiple speakers controlled and connected by a Mobile App which is disclosed in the present invention. Also the Patent US 20060046656 A1 presents bluetooth headset and a bluetooth device connectable to audio equipment. The Bluetooth headset and the bluetooth device are suitable for trans-receiving signals in a mobile communication device and an audio equipment. Both the Bluetooth headset and the bluetooth device at least comprise a bluetooth transceiver and an audio-in port. The bluetooth transceiver is used to trans-receive signals from the mobile communication device. The audio-in port connects the audio equipment. Wherein, when a calling signal from the mobile communication device is received by the bluetooth transceiver, the audio signal transmitted to the stereo headset connected to the bluetooth device is switched to the audio signal provided by the mobile communication device, and the audio signal transmitted to a speaker of the bluetooth headset is switched to the audio signal provided by the mobile communication device. However, none of the traditional patents or audio systems discloses the inventive features as are present in this portable device.

The present invention is an improvement in the sense that it describes a portable Bluetooth hub that allows the user to sync the device (invention) to multiple Bluetooth® speakers simultaneously and channel the audio to said synced devices at the same time allowing the user to listen to the same audio on multiple speakers at once. Prior to this invention the only option to listen to audio through Bluetooth® is through specific speakers that have integrated Bluetooth® chips. In addition, there are no patents or inventions that allow a user to sync existing 3^{rd} party Bluetooth® speakers to a hub that is in turn synced to a mobile phone app and controlled or operated via mobile phone app. Therefore, the present invention is personally and commercially an advantage over what already existed in prior art.

The limitations and non-effectiveness of the prior art has been overcome by the instant invention as described below.

### BRIEF SUMMARY OF THE INVENTION

The foregoing descriptions outline some pertinent features and objects of the present invention. These may be illustrative of more exhaustive and comprehensive features described later in the application. The technical terms used in this documents, are meant with the same meaning as understood by a typical expert of the field which is related to the invention

The present invention is a portable Bluetooth audio hub that connects to multiple Bluetooth devices in a single instance through a Mobile application.

In one embodiment of the invention, the user has to register in the App along with the ‘Serial Number’ of the portable device which is a Nine-digit number unique to the device. Once the user is registered, he may sync multiple devices to the App and create Groups. The user can stream the audio only to multiple connected devices at a single instance. User may also de-sync or ‘forget’ the devices to which he does not want to connect further.

The objective of the present invention is to provide an audio system which is convenient, compact and allows multiple Bluetooth speakers to be connected via the Mobile App. It present the device with a rechargeable battery and it is portable to be carried along with the users.

These and other features, objects and advantages of the present invention will be readily visible to the persons ordinarily skilled in the art related to this field comprehending in entirety the above characteristics, following descriptions and claims of the present invention

### BRIEF DESCRIPTION OF THE FLOWCHART

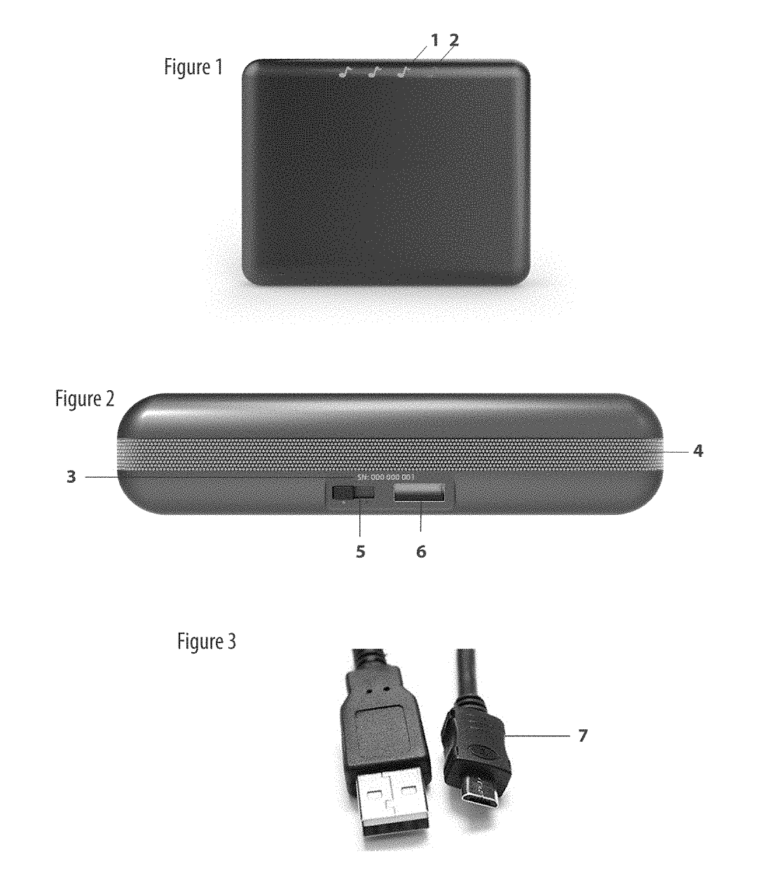

The FIG. 1 illustrates an example of the top of the portable Bluetooth® audio hub device.

The FIG. 2 illustrates an example of the bottom of the Bluetooth® audio hub device.

The FIG. 3 illustrates an example of the Micro USB charging cord and adaptors.

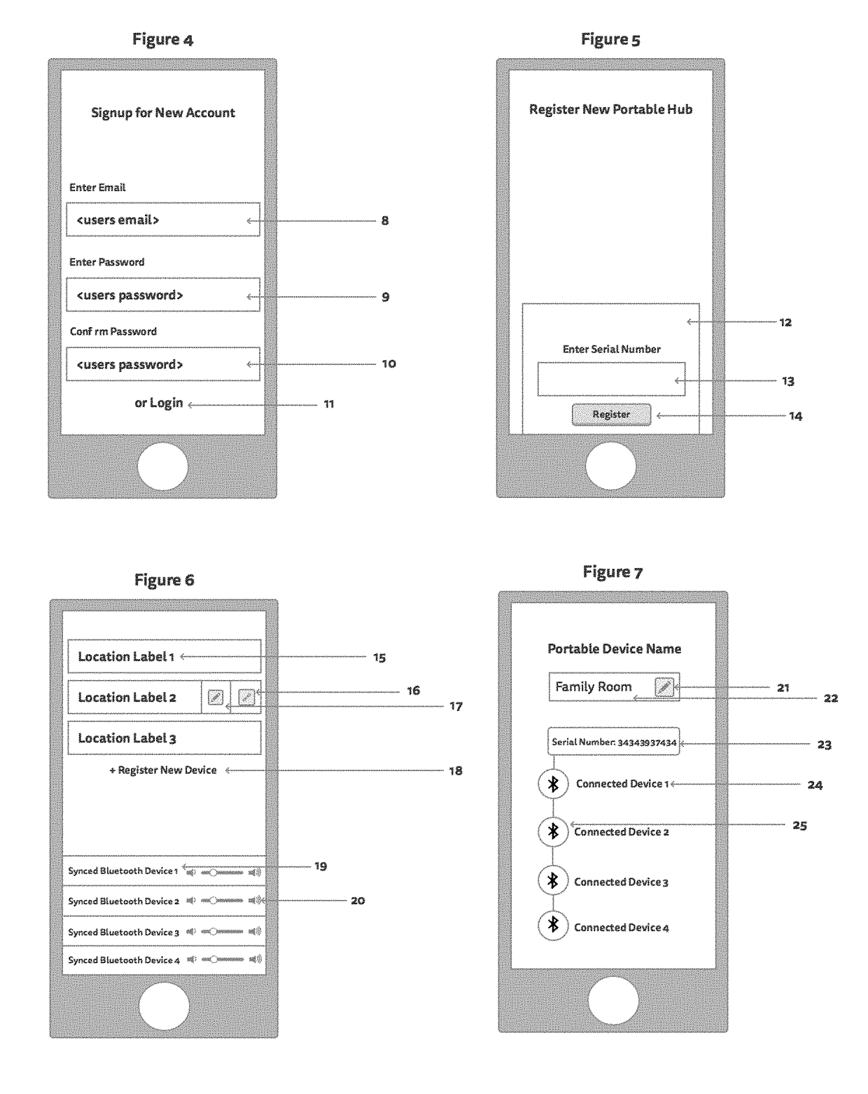

The FIG. 4 illustrates an example of the Mobile App's Login Screen.

The FIG. 5 illustrates an example of the Mobile App's Registration Screen.

The FIG. 6 illustrates an example of the Mobile App's Home Screen.

The FIG. 7 illustrates an example of the Mobile App's Edit Screen.

The FIG. 8 illustrates an example of the Mobile App's Search Screen.

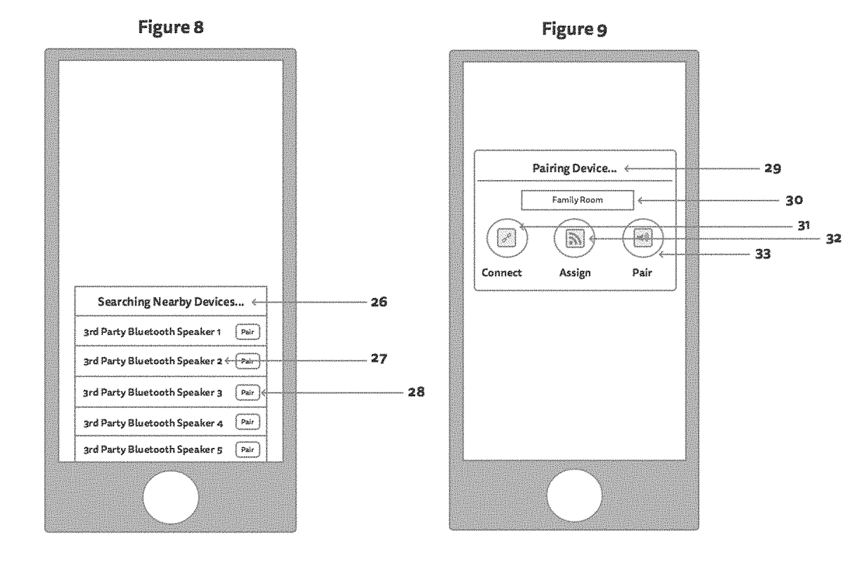

The FIG. 9 illustrates an example of the Mobile App's Syncing Screen.

### DETAILED DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized.

The FIG. 1 illustrates the top of the portable Bluetooth audio hub device. It is a rectangular compact device with LED Bluetooth Connection lights. When Bluetooth connection light is ON (1), it signifies an active Bluetooth connection. When LED Bluetooth connection light is OFF (2), it signifies an inactive Bluetooth connection. The device will allow up to multiple active bluetooth connections at once therefore up to multiple lights can be lit simultaneously. The FIG. 2 depicts the bottom of the Bluetooth® audio hub device. The device serial number (3) is the unique identifier [blue coloured]. Each portable hub will have a unique 9 digit alphanumeric serial number. The purpose of the serial number is: (a) to identify the portable hub; (b) used as security to guard against theft and (c) to register the portable device through the mobile app and pair the portable device with the user's account in order to ensure only one user can connect to the device at one time. When the device is charged at 30% or more then the color or the LED will be aqua colored. When the device charge is 29% or less then the LED will turn red in color. When the device is being charged then the device will be flicker red and turn a solid aqua color once fully charged (4). The device also has a Power Switch (5) present to the left over the green dot which wilt turn the Power ON. A switch to the right over the red dot will turn power off to the portable device (5). Next to the switch, is the Micro USB power input (6) whose purpose is to charge the portable device's rechargeable battery and allow the device to power on in the event the battery is out of charge. The FIG. 3 shows the Micro USB charging cord and adaptors. This cord (7) will connect to the device by using the micro USB end and the USB adapter can connect to wall chargers or computers for charging. The Micro USB adaptor will also serve to update the portable device's firmware in the event an update is released. The Micro USB cord will connect to the portable device and the USB adaptor will connect to a computer's USB input, the user can then update the firmware of the portable device through the internet from a specified secure address and web server.

The FIG. 4 illustrates an instance of the Mobile App's (Application) Login Screenthrough which the User will operate the device and sync other bluetooth speakers. For starting with the portable device, User's Email ID is required in order to setup an Account on the App (8). A user's unique password (alphanumeric up to 16 characters) is also required in order to set up an account on the app (9). The App prompts user to confirm the password he has entered (10). An existing user may login by selecting “login” (11). The FIG. 5 illustrates the Mobile App's Registration Screen which has a tab to enter the Serial number of the device (13) for the mobile app to (a) ensure serial number is a valid serial number by checking company's serial number database, (b) ensure the serial number is not previously reported lost or stolen. If reported lost or stolen, the app will notify the user to follow a link that will guide the user to mail the equipment back to the company for return. Lastly, (c) pairing the serial number to users app account for registry and single use. A pop up will slide up from the bottom of the app when the user is ready to register a new portable device (12). Pressing the register button (14) will perform all actions above detailed in chronological order.

The FIG. 6 shows the Mobile App's Home Screen which has tabs relating to ‘Location Label 1, 2, 3, etc (15). After the portable device is registered to the users account, the user will be able to label the portable device what he/she may choose, this will be to identify the portable device through these location labels from any additional portable devices the user may own. There is no limit to the amount of portable devices a user can register to his/her account. By performing a “slide left” action, the user will be able to “unsync” their app from the specified portable device (16). By performing a “slide left” action, the user will be able to “edit” the 3^{rd} party bluetooth devices that are actively connected or “synced” to the specified portable device (17). By pressing the “Register New Device” the user will be prompted with a popup that will allow the user to register a new portable device to the user's app account (18). All “active” synced 3^{rd} party Bluetooth devices will show here along with the manufacturer model name. If the device has been synced in the past but is not active then it will be shown but not lit up. Only “active” connections will be lit up (19). The user will be able to lower or raise the audio volume for all “active” 3^{rd} party Bluetooth connection's by sliding the knob left (lower volume) or right (higher volume) (20).

The FIG. 7 presents the Mobile App's Edit Screen as shown via (17) by pressing the edit button (21). The user will be able to type in their own “location label” they would like to identify their portable device (22). The registered portable hub's serial number will show here. If the user presses and holds down this button then the user will be able to (a) “unregister” this account with the currently registered account or (b) temporarily allow another account to connect to and control this portable device (23). The Bluetooth icons (24) present on the screen show the manufacturers model name of the connected 3^{rd} party Bluetooth device for channel 1. By tapping bluetooth icon button as shown (25) the user will be able to “resync” to this device. By holding down this icon button for 2+ seconds the user will be prompted with “Forget this device” and two options of YES or NO. The user may do accordingly.

The FIG. 8 shows the Mobile App's Search Screen where the App will begin to Search nearby devices automatically or on pressing the icon (26) which will return the manufacturer name of the device that is “pairable” or “syncable” (27). The mobile application would only return results of hardware that can be used with the mobile application and device. After the results are returned to the user, the user will be able to press “pair” (29). Upon pressing the “pair” button, the mobile application will show a popup that displays the pairing, syncing and assigning process.

The final syncing process is illustrated in the FIG. 9 where the App will indicate that it is pairing with the nearby devices (29). There is also a label (30) which is the name of the portable hub device or “label” that the user chose to name this portable hub for organization and recognition purposes. The label ‘Connect’ (31) is the first step of the pairing process and when lit, will illustrate to the user that the mobile phone is first connecting to the portable hub. The Label ‘Assign’ (32) is the second step of the pairing process and when lit, will illustrate to the user that the mobile phone is assigning the specified 3^{rd} Party Bluetooth device to the portable Bluetooth device. The last step of pairing process comes up with the Label ‘Pair’ when lit, it will illustrate to the user that the mobile phone is pairing the specified 3^{rd} Party Bluetooth device to the portable Bluetooth device and to the mobile phone for a completed pair.

Although the invention has been explained in relation to its preferred embodiment, it is to be understood that many other possible modifications and variations can be made without departing from the spirit of the scope of the invention.

What is claimed for is:

1. An apparatus which is portable Bluetooth audio hub that connects to multiple Bluetooth devices in a single instance through a Mobile application.

2. The invention in claim 1 comprising of:
the capability to register in the App along with the ‘Serial Number’ of the portable device which is a nine-digit number unique to the device;
the capability of syncing multiple devices to the App and create Groups;
the capability to stream the audio only to multiple connected devices at a single instance;
the capability to de-sync or ‘forget’ the devices to which he does not want to connect further.

3. The apparatus in claim 1 providing the feature of multiple Bluetooth speakers to be connected via the Mobile App.

4. The apparatus in claim 1 having the capacity to add up to multiple active bluetooth connections at once therefore up to multiple lights can be lit simultaneously to display the number of active connections.

5. The apparatus in claim 1 having a serial number which identifies the portable hub, can be used as security to guard against theft and to register the portable device through the mobile app and pair the portable device with the user's account in order to ensure only one user can connect to the device at one time.

6. The apparatus in claim 1 having LED to show the level of battery available to an user.

7. The apparatus in claim 1 having capability of being connected to a device in order to receive a firmware update.

8. The apparatus in claim 1 having the capability of labeling the portable devices with “location labels”.
